(19) United States
(12) Patent Application Publication
(10) Pub. No.: US 2026/0112302 A1
(43) Pub. Date: Apr. 23, 2026

(54) DISPLAY CIRCUIT BOARD, ELECTRONIC DEVICE INCLUDING DISPLAY CIRCUIT BOARD, AND METHOD OF DRIVING ELECTRONIC DEVICE

(71) Applicant: Samsung Display Co., LTD., Yongin-si (KR)

(72) Inventors: Yunki Baek, Yongin-si (KR); Sooyeon Lee, Yongin-si (KR); Hyeonmin Kim, Yongin-si (KR); Jongwoong Park, Yongin-si (KR)

(21) Appl. No.: 19/355,059

(22) Filed: Oct. 10, 2025

(30) Foreign Application Priority Data
Oct. 18, 2024 (KR) 10-2024-0143260

(51) Int. Cl. G09G 3/20; G09G 3/32

(52) U.S. Cl. CPC G09G 3/2096; G09G 3/2048; G09G 3/32; G09G 2320/0233; G09G 2320/0257; G09G 2320/045; G09G 2340/16; G09G 2360/127; G09G 2360/16

(57) ABSTRACT

Provided are a display circuit board, an electronic device including the display circuit board, and a method of driving the electronic device. The display circuitry board includes a memory and an auxiliary processor, wherein the auxiliary processor is configured to read and decode a stress table from a memory, output a second image obtained by compensating for a first image based on the stress table, generate new stress data for one slice, based on a grayscale of the second image, generate second accumulated stress data by summing first accumulated stress data read from the stress table and the new stress data, encode the second accumulated stress data such that the encoded second accumulated stress data has a data size equal to or less than a target size, and store the encoded second accumulated stress data to the memory.

### CROSS-REFERENCE TO RELATED APPLICATION

This application claims priority to Korean Patent Application No. 10-2024-0143260, filed on Oct. 18, 2024, and all the benefits accruing therefrom under 35 U.S.C. § 119, the content of which in its entirety is herein incorporated by reference.

### BACKGROUND

### 1. Field

One or more embodiments relate to a display circuit board, an electronic device including the display circuit board, and a method of driving the electronic device, and more particularly, to an electronic device for displaying a high-quality image and a method of driving the electronic device.

### 2. Description of the Related Art

An electronic device may include a display panel for displaying information processed by the electronic device. The display panel may include sub-pixels emitting green light, red light, and blue light, respectively. Each sub-pixel may include a display element such as, for example, a light-emitting diode, and transistors and capacitors for controlling the display element.

As a driving time of the display panel elapses, degradation characteristics of the sub-pixels may vary. Accordingly, a difference in luminance between the sub-pixels may occur, and an afterimage or other effect may be recognized by a user.

### SUMMARY

In order to compensate for an afterimage, an electronic device may generate accumulated stress data of a display panel and may adjust a luminance of sub-pixels based on the accumulated stress data. In this case, excessive data truncation may occur in a process of processing data to reduce the volume of the accumulated stress data.

One or more embodiments include a display circuit board, an electronic device for displaying a high-quality image by reducing data truncation during afterimage compensation and a method of driving the electronic device. However, the embodiments are examples and do not limit the scope of the disclosure.

Additional aspects will be set forth in part in the description which follows and, in part, will be apparent from the description, or may be learned by practice of the presented embodiments.

According to one or more embodiments, a display circuit board includes an auxiliary processor which reads and decodes a stress table from a memory, outputs a second image obtained by compensating for a first image based on the stress table, generates new stress data for one slice, based on a grayscale of the second image, generates second accumulated stress data by summing first accumulated stress data read from the stress table and the new stress data, encodes the second accumulated stress data such that the encoded second accumulated stress data has a data size equal to or less than a target size, and stores the encoded second accumulated stress data to the memory.

In an embodiment, the auxiliary processor may, when encoding the second accumulated stress data, estimate a prediction value of a current stress element by using a function of previous stress elements.

In an embodiment, the auxiliary processor may, based on a determination that a data size of the second accumulated stress data encoded by using a first prediction method is greater than the target size, re-encode the second accumulated stress data by using a second prediction method different from the first prediction method.

In an embodiment, the auxiliary processor may, based on a determination that a data size of the second accumulated stress data re-encoded by using the second prediction method is greater than the target size, increase a quantization level and re-encode the second accumulated stress data by using the first prediction method.

In an embodiment, a size of the one slice may be determined such that the second accumulated stress data is repeatedly encoded a certain number of times during one frame.

In an embodiment, one of the first prediction method and the second prediction method may include estimating a function value of three stress elements adjacent to a current stress element as a prediction value, and the other of the first prediction method and the second prediction method may include estimating a value having a higher similarity to a value of the current stress element from among two stress elements adjacent to the current stress element as the prediction value.

In an embodiment, the second accumulated stress data may include a bit indicating a used prediction method from among the first prediction method and the second prediction method.

In an embodiment, the auxiliary processor may generate the second accumulated stress data by further adding dithering data to the first accumulated stress data and the new stress data.

In an embodiment, the auxiliary processor may update the stress table for one slice during one frame.

In an embodiment, the auxiliary processor may group a plurality of sub-pixels into blocks and store an average value of stresses of sub-pixels belonging to a block as a new stress element of the block.

In an embodiment, the auxiliary processor may encode the second accumulated stress data by using an entropy coding method.

According to one or more embodiments, an electronic device includes a display panel, and a display circuit board including an auxiliary processor, wherein the auxiliary processor reads and decodes a stress table from a memory, outputs a second image obtained by compensating for a first image based on the stress table, generates new stress data for one slice, based on a grayscale of the second image, generates second accumulated stress data by summing first accumulated stress data read from the stress table and the new stress data, encodes the second accumulated stress data such that the encoded second accumulated stress data has a data size equal to or less than a target size, and stores the encoded second accumulated stress data to the memory.

According to one or more embodiments, a method of driving an electronic device includes reading and decoding a stress table from a memory, outputting a second image obtained by compensating for a first image based on the stress table, generating new stress data for one slice, based on a grayscale of the second image, generating second accumulated stress data by summing first accumulated stress data read from the stress table and the new stress data, encoding the second accumulated stress data such that the encoded second accumulated stress data has a data size equal to or less than a target size, and storing the encoded second accumulated stress data to the memory.

In an embodiment, the encoding of the second accumulated stress data may include encoding the second accumulated stress data by using a first prediction method, comparing a data size of the second accumulated stress data encoded by using the first prediction method with the target size, and based on determining the data size is greater than the target size, re-encoding the second accumulated stress data by using a second prediction method different from the first prediction method.

In an embodiment, the encoding of the second accumulated stress data may further include comparing a data size of the second accumulated stress data re-encoded by using the second prediction method with the target size, and based on determining the data size is greater than the target size, increasing a quantization level and re-encoding the second accumulated stress data by using the first prediction method.

In an embodiment, one of the first prediction method and the second prediction method may include estimating a function value of three stress elements adjacent to a current stress element as a prediction value, and the other of the first prediction method and the second prediction method may include estimating a value having a higher similarity to a value of the current stress element from among two stress elements adjacent to the current stress element as the prediction value.

In an embodiment, the generating of the second accumulated stress data may further include adding dithering data to the first accumulated stress data and the new stress data.

In an embodiment, the stress table may be updated for one slice per frame.

In an embodiment, the generating of the new stress data may include grouping a plurality of sub-pixels into blocks, and storing an average value of stresses of sub-pixels belonging to a block as a new stress element of the block.

In an embodiment, the block may include 2×2 adjacent sub-pixels.

In an embodiment, the second accumulated stress data may be encoded by using an entropy coding method.

Other aspects, features, and advantages of the disclosure will become more apparent from the drawings, the claims, and the detailed description.

These general and specific embodiments may be implemented by using a system, a method, a computer program, or a combination thereof.

### BRIEF DESCRIPTION OF THE DRAWINGS

The above and other aspects, features, and advantages of certain embodiments will be more apparent from the following description taken in conjunction with the accompanying drawings, in which:

FIG. 1 is a perspective view illustrating an electronic device, according to an embodiment;

FIG. 2 is an exploded perspective view illustrating an electronic device, according to an embodiment;

FIG. 3 is a block diagram illustrating an electronic device, according to an embodiment;

FIG. 4 is a block diagram schematically illustrating a data conversion circuit, according to an embodiment;

FIG. 5 is a block diagram schematically illustrating an encoder and a decoder, according to an embodiment;

FIG. 6 is a flowchart schematically illustrating an operation of a bit rate controller, according to an embodiment;

FIG. 7 is a diagram schematically illustrating stress elements of second accumulated stress data; and

FIGS. 8 and 9 are diagrams schematically illustrating a display panel, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are described herein, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the disclosure allows for various changes and numerous embodiments, certain embodiments will be illustrated in the drawings and described in the detailed description. Effects and features of the disclosure, and methods for achieving them will be clarified with reference to embodiments described herein in detail with reference to the drawings. However, the disclosure is not limited to the following embodiments and may be embodied in various forms.

Hereinafter, embodiments will be described in detail with reference to the accompanying drawings, wherein the same or corresponding elements are denoted by the same reference numerals throughout and a repeated description thereof is omitted.

While such terms as “first,” “second,” or the like may be used to describe various components, such components are not be limited to the above terms. The above terms are used only to distinguish one component from another.

The singular forms “a,” “an,” and “the” as used herein are intended to include the plural forms as well unless the context clearly indicates differently.

It will be understood that the terms “including” and “having” are intended to indicate the existence of the features or elements described in the specification, and are not intended to preclude the possibility that one or more other features or elements may exist or may be added.

It will be further understood that, when a layer, region, or component is referred to as being “on” another layer, region, or component, it may be directly on the other layer, region, or component, or may be indirectly on the other layer, region, or component with intervening layers, regions, or components therebetween.

In the specification, it will be understood that when a layer, a region, or a component is referred to as being “connected” to another layer, region, or component, it may be “directly connected” to the other layer, region, or component and/or may be “indirectly connected” to the other layer, region, or component with other layers, regions, or components interposed therebetween. In an example in which a layer, a region, or a component is referred to as being “electrically connected,” it may be directly electrically connected, and/or may be indirectly electrically connected with intervening layers, regions, or components therebetween.

“A and/or B” is used herein to select only A, select only B, or select both A and B. “At least one of A and B” is used to select only A, select only B, or select both A and B.

In the specification, an x-direction, a y-direction, and a z-direction are not limited to directions along three axes of the rectangular coordinate system, and may be interpreted in a broader sense. For example, the x-direction, the y-direction, and the z-direction may be perpendicular to one another, or may represent different directions that are not perpendicular to one another.

When a certain embodiment may be implemented differently, a specific step order may be different from the described order. For example, two consecutively described steps may be performed substantially at the same time or may be performed in an order opposite to the described order.

The term “substantially,” as used herein, means approximately or actually. The term “substantially at the same time” means approximately or actually at the same time.

The term “substantially equal” means approximately or actually equal. The term “substantially the same” means approximately or actually the same. The term “substantially perpendicular” means approximately or actually perpendicular. The term “substantially parallel” means approximately or actually parallel.

Sizes of components in the drawings may be exaggerated or reduced for convenience of explanation. For example, because sizes and thicknesses of components in the drawings are arbitrarily illustrated for convenience of explanation, the disclosure is not limited thereto.

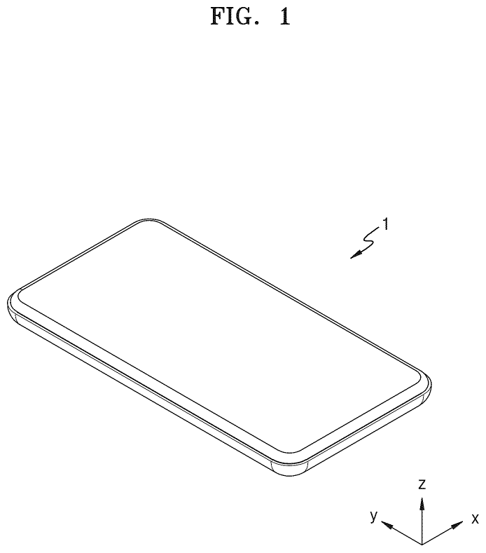

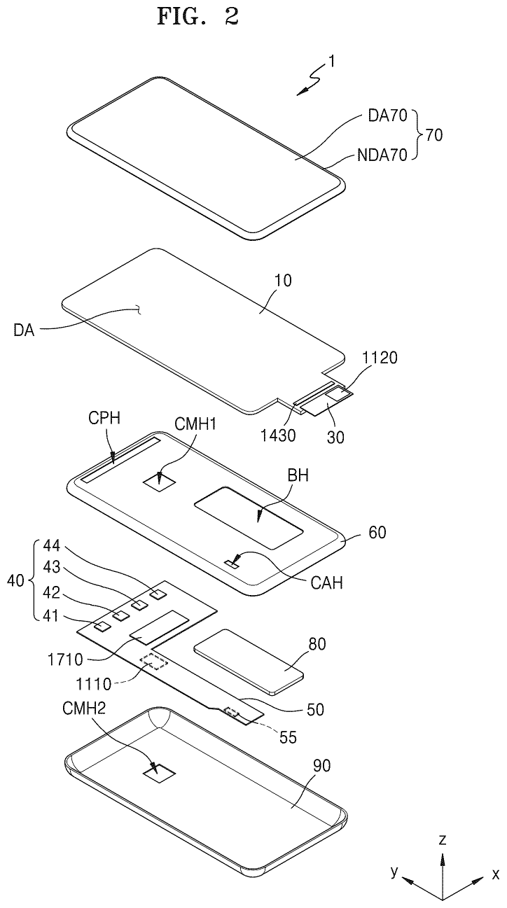

FIG. 1 is a perspective view illustrating an electronic device, according to an embodiment. FIG. 2 is an exploded perspective view illustrating an electronic device, according to an embodiment.

Referring to FIGS. 1 and 2, an electronic device 1 according to an embodiment is a device for displaying a moving image or a still image, and may be used not only in a portable electronic device such as, for example, a mobile phone, a smartphone, a tablet personal computer (PC), a mobile communication terminal, an electronic organizer, an electronic book, a portable multimedia player (PMP), a navigation device, or an ultra-mobile PC (UMPC) but also in any of various devices such as, for example, a television, a laptop computer, a monitor, an advertisement board, or an Internet of things (IoT) device. The electronic device 1 according to an embodiment may be used in a wearable device such as, for example, a smart watch, a watch phone, a glasses-type display, or a head-mounted display (HMD). The electronic device 1 according to an embodiment may be used as a center information display (CID) located on an instrument panel, a center fascia, or a dashboard of a vehicle, a room mirror display replacing a side-view mirror of a vehicle, or a display located on the back of a front seat for entertainment of a rear seat passenger of a vehicle.

For convenience of description, the electronic device 1 according to an embodiment is a smartphone in FIGS. 1 and 2. The electronic device 1 according to an embodiment may include a cover window 70, a display panel 10, a data driver 1430, a display circuit board 30, a component 40, a bracket 60, a main circuit board 50, a battery 80, and a lower cover 90.

In the specification, “left,” “right,” “upper,” and “lower” in a plan view refer to directions when the display panel 10 is viewed in a direction perpendicular to the display panel 10. For example, “left” refers to a −x direction, “right” refers to a +x direction, “upper” refers to a +y direction, and “lower” refers to a −y direction.

The electronic device 1 may have a rectangular shape in a plan view. For example, the electronic device 1 may have a rectangular planar shape with a short side in a first direction (x direction) and a long side in a second direction (y direction) as illustrated in FIG. 1. A corner at which the short side in a first direction (the x direction) and the long side in a second direction (the y direction) meet each other may have a rounded shape with a certain curvature or may be formed at a right angle. A planar shape of the electronic device 1 is not limited to a rectangular shape, and may be another polygonal shape, an elliptical shape, or an irregular shape.

The cover window 70 may be disposed on the display panel 10 and cover a top surface of the display panel 10. Accordingly, the cover window 70 may protect the top surface of the display panel 10.

The cover window 70 may include a transmissive cover portion DA70 corresponding to the display panel 10 and a light-blocking cover portion NDA70 surrounding the transmissive cover portion DA70. The light-blocking cover portion NDA70 may include an opaque material for blocking light (e.g., a colored opaque material). The light-blocking cover portion NDA70 may include a pattern that may be illustrated to a user when an image is not displayed.

The display panel 10 may be disposed under the cover window 70. The display panel 10 may overlap the transmissive cover portion DA70 of the cover window 70.

The display panel 10 includes a display area DA. The display area DA where an image is displayed may include an area (hereinafter, referred to as a component area) where light emitted from the components 40 disposed under the display panel 10 is transmitted. The components 40 may include external modules such as, for example, a sensor or a camera using visible light, infrared light, or sound.

The display panel 10 may be a light-emitting display panel including a light-emitting diode. The light-emitting diode may include an organic light-emitting diode including an organic emission layer. In some embodiment, the light-emitting diode may be an inorganic light-emitting diode including an inorganic material. The inorganic light-emitting diode may include a PN junction diode including inorganic semiconductor-based materials.

The display panel 10 may be a rigid display panel that is rigid and is not easily bent, or a flexible display panel that is flexible and may be easily bent, folded, or rolled. For example, the display panel 10 may be a foldable display panel that may be folded and unfolded, a curved display panel having a curved display surface, a bended display panel in which a portion other than a display surface is bent, a rollable display panel that may be rolled or unrolled, and a stretchable display panel that may be stretched.

The display panel 10 may be a transparent display panel that is transparent such that an object or a background disposed on a bottom surface of the display panel 10 is viewed from the top surface of the display panel 10. Alternatively, the display panel 10 may be a reflective display panel capable of reflecting an object or a background on the top surface of the display panel 10.

The data driver 1430 may be mounted as an integrated circuit (IC) on the display panel 10. In another embodiment, the data driver 1430 may be disposed on the display circuit board 30.

The display circuit board 30 may be attached to one side of the display panel 10. The display circuit board 30 may be a flexible printed circuit board (FPCB) that may be bent, a rigid printed circuit board (PCB) that is rigid and not easily bent, or a composite printed circuit board including both a rigid printed circuit board and a flexible printed circuit board.

In an embodiment, the touch sensor driver may be disposed on the display circuit board 30. The touch sensor driver may be formed as an IC. The touch sensor driver may be attached to the display circuit board 30. The touch sensor driver may be electrically connected to touch electrodes of a touchscreen layer of the display panel 10 through the display circuit board 30. In some embodiments, the touch sensor driver may be integrated with the data driver 1430.

The touchscreen layer of the display panel 10 may detect a touch input of the user by using at least one of various touch methods such as, for example, a resistive method or a capacitive method. In an example in which the touch screen layer of the display panel 10 detects a touch input of the user by using a capacitive method, the touch sensor driver may apply driving signals to driving electrodes from among the touch electrodes, and may determine whether the user touches by detecting voltages charged by mutual capacitance between the driving electrodes and sensing electrodes through the sensing electrodes from among the touch electrodes. The user's touch may include a contact touch and a proximity touch. The contact touch means that an object such as, for example, the user's finger or a pen directly contacts the cover window 70 disposed on the touchscreen layer. The proximity touch means that an object such as, for example, the user's finger or a pen is located close to the cover window 70, such as, for example, hovering. The touch sensor driver may transmit sensor data to a main processor 1110 according to the detected voltages, and the main processor 1110 may calculate touch coordinates where the touch input occurs by analyzing the sensor data.

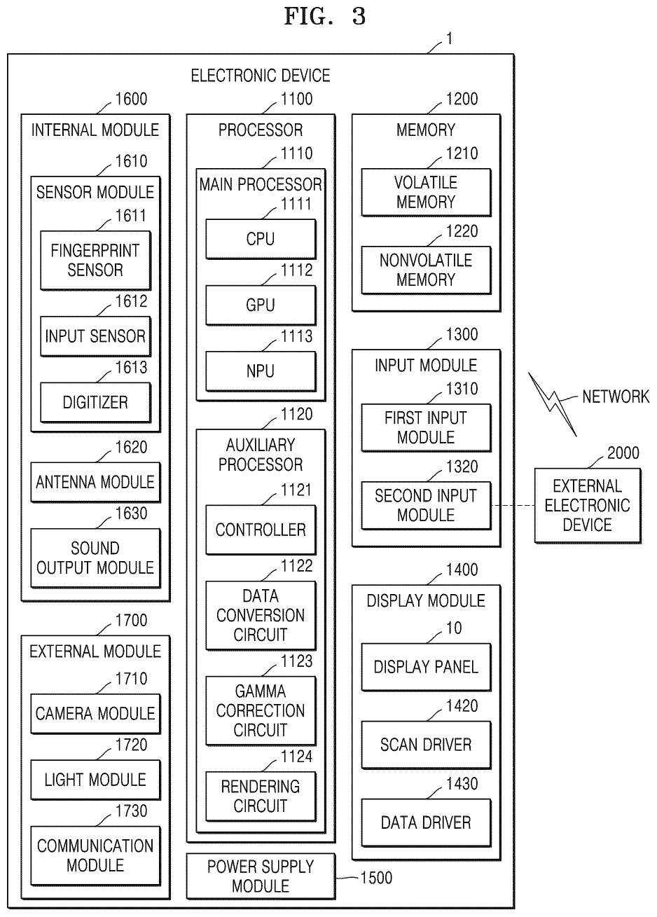

In an embodiment, an auxiliary processor 1120 for driving pixels of the display panel 10, a scan driver 1420 (see FIG. 3), and the data driver 1430 may be disposed on the display circuit board 30. In another embodiment, the auxiliary processor 1120 may be included in the display circuit board 30.

The bracket 60 supporting the display panel 10 may be disposed under the display panel 10. The bracket 60 may include plastic, metal, or both plastic and metal. A first camera hole CMH1 into which a camera module 1710 is inserted, a battery hole BH in which the battery 80 is disposed, and a cable hole CAH through which a cable connected to the display circuit board 30 passes may be formed in the bracket 60. A component hole CPH overlapping the display panel 10 may be formed in the bracket 60. The component hole CPH may overlap the components 40 of the main circuit board 50 in a third direction (z direction). In an embodiment, the display area DA of the display panel 10 may overlap the components 40 of the main circuit board 50 in the third direction (the z direction). In another embodiment, the component hole CPH may not be formed in the bracket 60.

In an embodiment, the components 40 may include first to fourth components 41, 42, 43, and 44 overlapping the display panel 10. The first to fourth components 41, 42, 43, and 44 may be respectively provided as a proximity sensor, an illumination sensor, an iris sensor, a facial recognition sensor, and a camera (or an image sensor). The proximity sensor using infrared rays may detect an object located close to a top surface of the electronic device 1, and the illumination sensor may detect a brightness of light incident on the top surface of the electronic device 1. In some aspects, the iris sensor may capture an image of an iris of a person located over the top surface of the electronic device 1, and the camera may capture an image of the object located over the top surface of the electronic device 1. The components 40 are not limited to the proximity sensor, the illumination sensor, the iris sensor, the facial recognition sensor, and the camera, and various modules may be arranged.

The main circuit board 50 and the battery 80 may be disposed under the bracket 60. The main circuit board 50 may be a rigid printed circuit board or a flexible printed circuit board.

The main circuit board 50 may include the main processor 1110, the camera module 1710, a main connector 55, and the components 40. The main processor 1110 may be formed as an IC. The camera module 1710 may be disposed on both a top surface and a bottom surface of the main circuit board 50, and each of the main processor 1110 and the main connector 55 may be disposed on any one of the top surface and the bottom surface of the main circuit board 50.

The camera module 1710 processes an image frame such as, for example, a still image or a moving image obtained by an image sensor in a camera mode and outputs the image frame to the main processor 1110. The camera module 1710 may include at least one of a camera sensor (e.g., CCD or CMOS), a photo sensor (or image sensor), and a laser sensor. The camera module 1710 may be connected to the image sensor among the components 40 and may process an image input through the image sensor.

A cable passing through the cable hole CAH of the bracket 60 may be connected to the main connector 55, and thus, the main circuit board 50 may be electrically connected to the display circuit board 30.

The lower cover 90 may form an outer appearance of the electronic device 1, and an opening through which a part of the display panel 10 is exposed may be formed in a front surface of the lower cover 90. The lower cover 90 has a shape whose surface corresponding to the display panel 10 is open, and may be assembled to the display panel 10. The lower cover 90 may be located opposite to the cover window 70, with the display panel 10 between the lower cover 90 and the cover window 70. The lower cover 90 may be disposed under the main circuit board 50 and the battery 80. The lower cover 90 may be fastened and fixed to the bracket 60. The lower cover 90 may form an outer appearance of a bottom surface of the electronic device 1. The lower cover 90 may include plastic, metal, or both plastic and metal.

A second camera hole CMH2 through which a bottom surface of the camera module 1710 is exposed may be formed in the lower cover 90. A position of the camera module 1710 and positions of the first and second camera holes CMH1 and CMH2 corresponding to the camera module 1710 are not limited to those illustrated in FIG. 2 and may be changed in various ways.

FIG. 3 is a block diagram illustrating an electronic device, according to an embodiment.

Referring to FIG. 3, the electronic device 1 may include a processor 1100, a memory 1200, an input module 1300, a display module 1400, a power supply module 1500, an internal module 1600, and an external module 1700. According to an embodiment, in the electronic device 1, at least one of the components described as included in the electronic device 1 may be omitted or one or more other components may be added. According to an embodiment, some of the components (e.g., the internal module 1600) described as included in the electronic device 1 may be integrated into another component (e.g., the display module 1400).

The processor 1100 may control another component (e.g., hardware or software component) of the electronic device 1 connected to the processor 1100 by executing software and may perform various data processing or calculation. According to an embodiment, as at least part of data processing or calculation, the processor 1100 may store a command or data received from another component (e.g., the input module 1300, a sensor module 1610, or a communication module 1730) in a volatile memory 1210, may process the command or the data stored in the volatile memory 1210, and may store result data in a nonvolatile memory 1220.

The processor 1100 may include the main processor 1110 and the auxiliary processor 1120. The main processor 1110 may include at least one of a central processing unit (CPU) 1111 and an application processor (AP). The main processor 1110 may further include at least one of a graphics processing unit (GPU) 1112, a communication processor (CP), and an image signal processor (ISP). The main processor 1110 may further include a neural processing unit (NPU) 1113. The NPU is a processor specialized in processing an artificial intelligence (AI) model, and the AI model may be generated through machine learning. The AI model may include a plurality of artificial neural network layers. The artificial neural network may be, but not limited to, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination thereof. The AI model may include a software structure, in addition or alternatively, to a hardware structure. Among the described processing units and processors, at least two may be integrated into one unit (e.g., a single chip) or each may be implemented as an independent unit (e.g., a plurality of chips).

The auxiliary processor 1120 may include a controller 1121. The controller 1121 may include an interface conversion circuit and a timing control circuit. The controller 1121 receives an image signal from the main processor 1110, converts a data format of the image signal to meet the interface specification with the display module 1400, and outputs image data. The controller 1121 may output various control signals supportive of driving the display module 1400.

The auxiliary processor 1120 may further include a data processing circuit such as, for example, a data conversion circuit 1122, a gamma correction circuit 1123, and a rendering circuit 1124. The data conversion circuit 1122 may receive image data from the controller 1121, and may compensate for the image data such that an image is displayed at a desired luminance according to characteristics of the electronic device 1 or a user's settings, or may convert the image data to reduce power consumption or compensate for an afterimage.

The display panel 10 may include a plurality of pixels. Each pixel may include sub-pixels respectively emitting green light, red light, and blue light. Each sub-pixel may include a display element such as, for example, a light-emitting diode, and transistors and a capacitor for driving the display element. The light-emitting diode may be degraded by stress accumulated by driving. This stress may be proportional to a driving time, temperature, luminance, driving current, and voltage of a pixel. In an area where a certain image is continuously displayed such as, for example, a status bar, even when an output image changes, an afterimage may remain due to degradation of sub-pixels in the display panel 10. In order to reduce such an afterimage and provide a high-quality image, the data conversion circuit 1122 may track stress of sub-pixels and may adjust a luminance of the sub-pixels according to a preset degradation modeling curve.

The gamma correction circuit 1123 may convert image data or a gamma reference voltage such that an image displayed on the electronic device 1 has desired gamma characteristics. The rendering circuit 1124 may receive image data from the controller 1121, and may render the image data by considering a pixel arrangement of the display panel 10 applied to the electronic device 1. At least one of the data conversion circuit 1122, the gamma correction circuit 1123, and the rendering circuit 1124 may be integrated into another component (e.g., the main processor 1110 or the controller 1121).

The memory 1200 may store various data used by at least one component (e.g., the processor 1100 or the sensor module 1610) of the electronic device 1, and input data or output data for commands related to the various data. The memory 1200 may include at least one of the volatile memory 1210 and the nonvolatile memory 1220.

The input module 1300 may receive a command or data to be used in components (e.g., the processor 1100, the sensor module 1610, or a sound output module 1630) of the electronic device 1 from the outside of the electronic device 1 (e.g., the user or an external electronic device 2000).

The input module 1300 may include a first input module 1310 to which a command or data is input from the user and a second input module 1320 to which a command or data is input from the external electronic device 2000.

The first input module 1310 may include a microphone, a mouse, a keyboard, or a pen (e.g., a passive pen or an active pen). The first input module 1310 may include a mechanical input means or a touch input means such as, for example, a button, a dome switch, a jog wheel, or a jog switch located on a rear surface or a side surface of the electronic device 1. The touch input means may include a touchscreen layer of the display panel 10.

The second input module 1320 may be connected to various types of external electronic devices 2000 connected to the electronic device 1, by wire or wirelessly. According to an embodiment, the second input module 1320 may include a high-definition multimedia interface (HDMI), a universal serial bus (USB) interface, an SD card interface, or an audio interface. The second input module 1320 may include a connector for physically connecting the electronic device 1 to the external electronic device 2000, for example, an HDMI connector, a USB connector, an SD card connector, or an audio connector (e.g., a headphone connector). In response to the external electronic device 2000 being connected to the second input module 1320, the electronic device 1 may perform appropriate control related to the connected external electronic device 2000.

The display module 1400 visually provides information to the user. The display module 1400 may include the display panel 10, a scan driver 1420, and the data driver 1430.

The display panel 10 displays (outputs) information processed by the electronic device 1. The display panel 10 may display execution screen information of an application driven by the electronic device 1 or user interface (UI) or graphical user interface (GUI) information according to the execution screen information.

The scan driver 1420 may be mounted as a driving chip on the display panel 10. Alternatively, the scan driver 1420 may be directly formed on the display panel 10. For example, the scan driver 1420 may include an amorphous silicon thin-film transistor (TFT) gate driver circuit (ASG), a low-temperature polycrystalline silicon (LTPS) TFT gate driver circuit, or an oxide semiconductor TFT gate driver circuit (OSG) built in the display panel 10. The scan driver 1420 receives a control signal from the controller 1121, and outputs scan signals to the display panel 10 in response to the control signal.

The data driver 1430 receives a control signal from the controller 1121, converts image data into a data voltage that is an analog voltage in response to the control signal, and then outputs data voltages to the display panel 10.

The power supply module 1500 supplies power to components of the electronic device 1, The power supply module 1500 may include the battery 80 (see FIG. 2) that charges a power supply voltage. In some aspects, the power supply module 1500 may include a connection port, and the connection port may be included in the second input module 1320 to which an external charger for supplying power is connected to charge the battery 80. Alternatively, the power supply module 1500 may include a wireless power transmission/reception member to charge the battery 80 in a wireless manner. The wireless power transmission/reception member may include a plurality of antenna radiators in the form of coils. The power supply module 1500 may include a power management integrated circuit (PMIC). The PMIC supplies optimized power to each of the components of the electronic device 1.

The electronic device 1 may further include the internal module 1600 and the external module 1700. The internal module 1600 may include the sensor module 1610, an antenna module 1620, and the sound output module 1630. The external module 1700 may include a camera module 1710, a light module 1720, and the communication module 1730.

The sensor module 1610 may include touch electrodes of the touchscreen layer of the display panel 10 and a touch sensor driver. The sensor module 1610 may detect an input by the user's body part or an input by a pen, and may generate an electrical signal or a data value corresponding to the input. The sensor module 1610 may include at least one of a fingerprint sensor 1611, an input sensor 1612, and a digitizer 1613.

The fingerprint sensor 1611 may generate a data value corresponding to the user's fingerprint. The fingerprint sensor 1611 may include any one of an optical fingerprint sensor and a capacitive fingerprint sensor.

The input sensor 1612 may generate a data value corresponding to coordinate information of an input by the user's body part or an input by a pen. The input sensor 1612 generates a capacitance change amount due to the input as a data value. The input sensor 1612 may detect an input by the passive pen or may transmit and receive data to and from the active pen.

The input sensor 1612 may measure a bio-signal such as, for example, blood pressure, moisture, or body fat. In an example in which the user touches his/her body part to a sensor layer or a sensing panel and does not move for a certain period of time, the input sensor 1612 may detect a bio-signal based on a change in an electric field by the body part and may output information desired by the user to the display module 1400.

The digitizer 1613 may generate a data value corresponding to coordinate information of an input by the pen. The digitizer 1613 generates an electromagnetic change amount due to the input as a data value. The digitizer 1613 may detect an input by the passive pen or may transmit and receive data to and/from the active pen.

In an embodiment, at least one of the fingerprint sensor 1611, the input sensor 1612, and the digitizer 1613 may be embedded in the display panel 10. For example, at least one of the fingerprint sensor 1611, the input sensor 1612, and the digitizer 1613 may be formed through a continuous process with a process of forming pixel circuits and light-emitting diodes of the display panel 10. Accordingly, the display panel 10 may function as one of the input modules 1300 that provide an input interface between the electronic device 1 and the user and may also function as one of the display modules 1400 that provide an output interface between the electronic device 1 and the user.

In another embodiment, at least two of the fingerprint sensor 1611, the input sensor 1612, and the digitizer 1613 may be integrated into one sensing panel through the same process. The sensing panel may be disposed between the display panel 10 and the cover window 70 (see FIG. 2) disposed over the display panel 10, but the disclosure is not limited thereto.

The antenna module 1620 may include one or more antennas for transmitting a signal or power to the outside or receiving a signal or power from the outside. According to an embodiment, the communication module 1730 may transmit a signal to an external electronic device or may receive a signal from an external electronic device through an antenna suitable for a communication method. An antenna pattern of the antenna module 1620 may be integrated into one component (e.g., the display panel 10) of the display module 1400 or the input sensor 1612.

The sound output module 1630 is a device for outputting a sound signal to the outside of the electronic device 1 and may output sound data received from the communication module 1730 or stored in the memory 1200 in a call signal reception mode, a call mode or a recording mode, a voice recognition mode, or a broadcast reception mode. The sound output module 1630 may output a sound signal related to a function (e.g., a call signal reception sound or a message reception sound) performed in the electronic device 1. The sound output module 1630 may include a receiver and a speaker. At least one of the receiver and the speaker may be a sound generating device that is attached to the bottom of the display panel 10 and outputs sound by vibrating the display panel 10. The sound generating device may be a piezoelectric element or a piezoelectric actuator that contracts or expands according to an electrical signal, or an exciter that generates a magnetic force by using a voice coil and vibrates the display panel 10.

The camera module 1710 may capture a still image and a moving image. According to an embodiment, the camera module 1710 may include one or more lenses, image sensors, or image signal processors. The camera module 1710 may further include an infrared camera for measuring the presence or absence of the user, a location of the user, and a gaze of the user.

The light module 1720 may output a signal for notifying the occurrence of an event by using light of a light source, or may provide light for obtaining an image. Examples of the event may include message reception, call signal reception, missing call, alarm, schedule notification, email reception, and battery charging capacity information notification. The light module 1720 may include a light-emitting diode or a xenon lamp. The light module 1720 may emit light of a single color or multiple colors to a front surface or a rear surface of the electronic device 1. The light module 1720 may interoperate with the camera module 1710 or may independently operate.

The communication module 1730 may support establishing a wired or wireless communication channel between the electronic device 1 and the external electronic device 2000 and performing communication through the established communication channel. The communication module 1730 may include one or both of a wireless communication module such as, for example, a cellular communication module, a short range wireless communication module, or a global navigation satellite system (GNSS) communication module and a wired communication module such as, for example, a local area network (LAN) communication module or a power line communication module. The communication module 1730 may transmit and receive a wireless signal on the Internet by using at least one of wireless LAN (WLAN), wireless-fidelity (Wi-Fi), Wi-Fi direct, and digital living network alliance (DLNA). In some aspects, the communication module 1730 may support short-range communication by using at least one of Bluetooth™, radio frequency identification (RFID), infrared data association (IrDA), ultra-wideband (UWB), ZigBee, near-field communication (NFC), Wi-Fi, Wi-Fi direct, and wireless universal serial bus (USB). The various types of communication modules 1730 described herein may be implemented as one chip or may be implemented as separate chips.

The electronic device 1 outputs various information through the display module 1400 within an operating system. In an example in which the processor 1100 executes an application stored in the memory 1200, the display module 1400 provides application information to the user through the display panel 10.

The processor 1100 outputs a command or data to the display module 1400, the sound output module 1630, the camera module 1710, or the light module 1720, based on input image received from the input module 1300 or the sensor module 1610. For example, the processor 1100 may generate image data corresponding to input data and may output the image data to the display module 1400, or may generate command data corresponding to input data and may output the command data to the camera module 1710 or the light module 1720. In an example in which input data is not received for a certain period of time from the input module 1300, the processor 1100 may switch an operation mode of the electronic device 1 to a low power mode or a sleep mode to reduce power consumed by the electronic device 1.

The processor 1100 obtains an external input through the input module 1300 or the sensor module 1610, and executes an application corresponding to the external input. In an example in which the user selects a camera icon displayed on the display panel 10, the processor 1100 obtains a user input through the input sensor 1612 and activates the camera module 1710. The processor 1100 transmits image data corresponding to an image captured through the camera module 1710 to the display module 1400. The display module 1400 may display an image corresponding to the captured image through the display panel 10.

In another example, when personal information authentication is executed in the display module 1400, the fingerprint sensor 1611 obtains input fingerprint information as input data. The processor 1100 compares the input data obtained through the fingerprint sensor 1611 with authentication information stored in the memory 1200 and executes an application according to a comparison result. The display module 1400 may display information executed according to a logic of an application through the display panel 10.

In another example, when a music streaming icon displayed on the display module 1400 is selected, the processor 1100 obtains a user input through the input sensor 1612 and activates a music streaming application stored in the memory 1200. In an example in which a music execution command is input in the music streaming application, the processor 1100 activates the sound output module 1630 and provides sound information corresponding to the music execution command to the user.

Some of the components may be connected to each other through a communication method between peripheral devices (e.g., a bus, a general-purpose input/output (GPIO), a serial peripheral interface (SPI), a mobile industry processor interface (MIPI), or an ultra path interconnect (UPI) link) to exchange a signal (e.g., a command or data) with each other. In an embodiment, the main processor 1110 may transmit an image signal to the auxiliary processor 1120 through the MIPI.

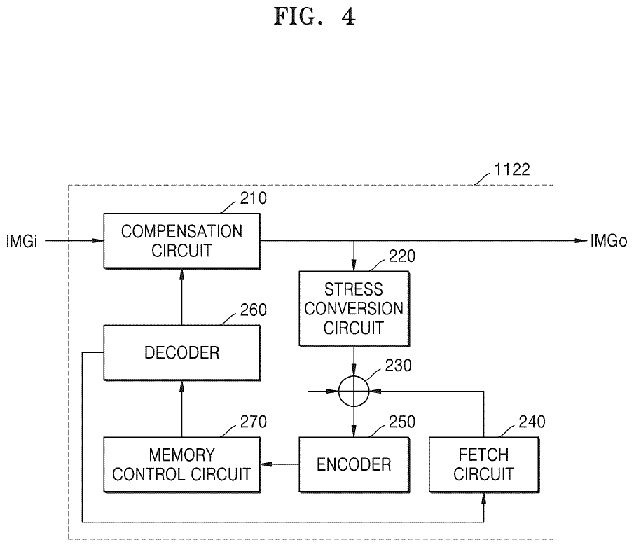

FIG. 4 is a block diagram schematically illustrating a data conversion circuit, according to an embodiment.

Referring to FIG. 4, the data conversion circuit 1122 may include a compensation circuit 210, a stress conversion circuit 220, a summing circuit 230, a fetch circuit 240, an encoder 250, a memory control circuit 270, and a decoder 260. Because the data conversion circuit 1122 is included in the auxiliary processor 1120 (see FIG. 2), an operation of the data conversion circuit 1122 or operations of components constituting the data conversion circuit 1122 may be represented as an operation of the auxiliary processor 1120. The auxiliary processor 1120 may be disposed on the display circuit board 30 (see FIG. 2).

At least a part of the memory 1200 (see FIG. 3) may store various data used by the auxiliary processor 1120, and input data or output data for commands related to the various data. At least a part of the memory 1200 used by the auxiliary processor 1120 may be disposed on the display circuit board 30.

The memory 1200 may store a stress table. The stress table may be a table of stress elements respectively indicating accumulated stress received by each sub-pixel of the display panel 10. Accumulated stress of each sub-pixel may be proportional to a driving time, temperature, luminance, driving current, and voltage of the sub-pixel, and a stress element may be a value for estimating accumulated stress of a corresponding sub-pixel.

At least a part of the stress table may be updated whenever a new image is displayed on the display panel 10. In an example in which a first image IMGi (input image) is input, the data conversion circuit 1122 may output a second image IMGo (output image) obtained by compensating for an afterimage, and may update the stress table by summing new stress of sub-pixels due to the output of the second image IMGo and accumulated stress.

In an embodiment, the data conversion circuit 1122 may update one slice per frame. In the specification, a slice refers to a unit obtained by dividing the stress table into a certain size. In an example in which the stress table has a size of 480×270 and one slice includes four lines, the stress table may be divided into 68 slices. One slice may correspond to an area having a substantially quadrangular shape in the display panel 10.

The stress table may be encoded (or decoded) in units of slices such that high-complexity compression technology is designed with a small logic size. In some aspects, when a certain portion of stress data is damaged, only a slice to which the data belongs is lost, thereby preventing an error from being propagated throughout the stress table.

The memory control circuit 270 may read the stress table from the memory 1200 and may transmit the stress table to the decoder 260, the decoder 260 may decode the stress table and may output the decoded stress table to the compensation circuit 210, and the compensation circuit 210 may output the second image IMGo obtained by compensating for the first image IMGi based on the stress table. The compensation circuit 210 may adjust a luminance (or a grayscale) of sub-pixels based on the stress table and a preset degradation modeling curve.

Stress received by each sub-pixel of the display panel 10 due to the displaying of the second image IMGo may be sampled (e.g., generated) by the stress conversion circuit 220. In this case, the stress conversion circuit 220 may generate new stress data for one slice per frame. Hereinafter, a slice which is updated when new stress data is generated in a current frame is referred to as a current slice. In an embodiment, the stress conversion circuit 220 may generate new stress data for a current slice, based on a grayscale of the second image IMGo.

In an embodiment, the stress conversion circuit 220 may reduce the size of new stress data by averaging stresses of adjacent sub-pixels. For example, the stress conversion circuit 220 may group a plurality of sub-pixels into blocks, may calculate an average value of stresses of sub-pixels belonging to a block, and may store the average value as a new stress element of the block.

Descriptions herein of sampling new stress data may include generating data which represents stress or acquiring a data sample which represents stress. For example, descriptions herein of sampling new stress data may include modeling or calculating an amount of stress with respect to elements (e.g., a slice, sub-pixels) described herein. In some examples, descriptions herein of sampling new stress data may include generating or calculating stress data based on a sampling of elements (e.g., a slice, sub-pixels).

Afterimage compensation may be performed for each color of the sub-pixels. In other words, adjacent sub-pixels among sub-pixels emitting light of the same color may be grouped into one block and new stress data may be calculated. For example, the stress conversion circuit 220 may group adjacent red sub-pixels into an R block, may calculate an average value of stresses of sub-pixels belonging to the R block, and may store the average value of stresses as a new stress element of the R block. Likewise, the stress conversion circuit 220 may group adjacent green sub-pixels into a G block, may group blue sub-pixels into a B block, and may calculate a new stress element of the G block and a new stress element of the B block.

One element of the stress table may be a function of stresses of sub-pixels included in one block. In an embodiment, one block may include 2×2 adjacent sub-pixels. In an embodiment, the stress conversion circuit 220 may omit a step of averaging stresses of sub-pixels in units of blocks, and may sample stress of each sub-pixel as a new stress data.

The fetch circuit 240 may read first accumulated stress data (or previously accumulated stress data of a current slice) including stress elements of the current slice from the stress table decoded by the decoder 260 and may transmit the first accumulated stress data to the summing circuit 230.

The summing circuit 230 may generate second accumulated stress data by summing the first accumulated stress data read from the stress table and the new stress data. In an embodiment, the summing circuit 230 may generate the second accumulated stress data by further adding dithering data to the first accumulated stress data and the new stress data. The dithering data may include artificially generated noise, in order to prevent a false contour line or Mach's phenomenon due to data compression. The summing circuit 230 may compensate for a truncation error due to data compression, by adding the dithering data.

The encoder 250 may encode the second accumulated stress data output from the summing circuit 230 such that the encoded second accumulated stress data has a data size (used-bit) equal to or less than a target size (target-bit). The encoder 250 may use a prediction method of estimating a prediction value of a current stress element by using a function of previous stress elements. The encoder 250 may use any one of at least two prediction methods, and may compress the second accumulated stress data by using an entropy encoding method. The entropy encoding method may include a Huffman coding method and an arithmetic coding method. The encoded second accumulated stress data may include a bit indicating a used prediction method.

In response to determining that a data size of the encoded second accumulated stress data is greater than the target size, the encoder 250 may re-encode the second accumulated stress data by using a prediction method different from the previously used prediction method In response to determining that a data size of the encoded second accumulated stress data is still greater than the target size, the encoder 250 may reduce encoding precision and re-encode the second accumulated stress data by changing a prediction method. The encoder 250 may control a data size of the encoded second accumulated stress data to be equal to or less than the target size through iteration.

In response to determining that a data size of the encoded second accumulated stress data is equal to or less than the target size, the encoded second accumulated stress data may be stored to the memory 1200 through the memory control circuit 270. Accordingly, the current slice of the stress table may be updated.

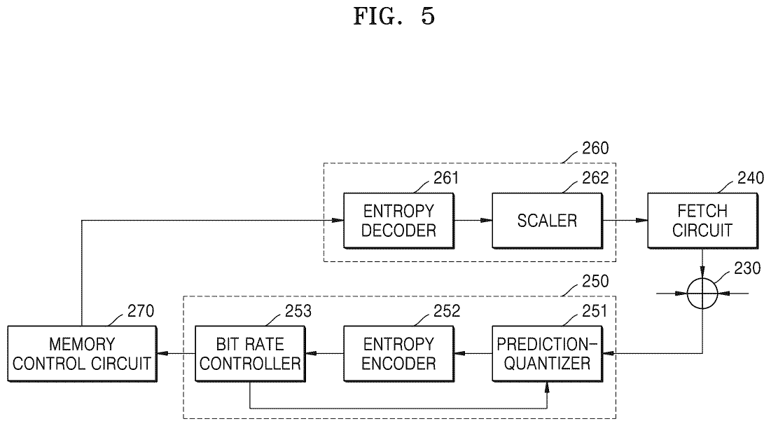

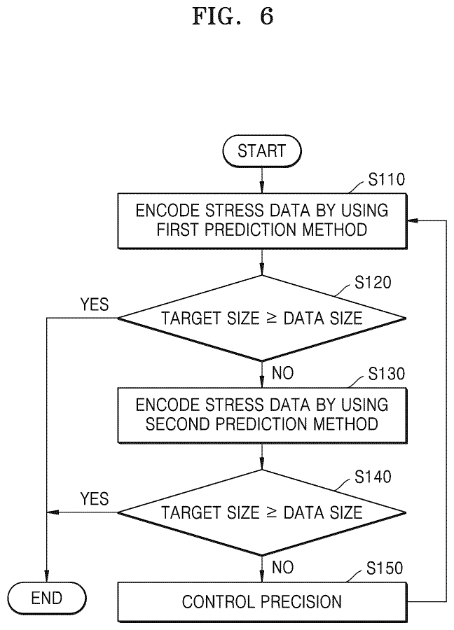

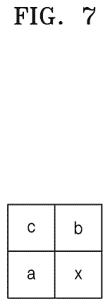

FIG. 5 is a block diagram schematically illustrating an encoder and a decoder, according to an embodiment. FIG. 6 is a flowchart schematically illustrating an operation of a bit rate controller, according to an embodiment. FIG. 7 is a diagram schematically illustrating stress elements of second accumulated stress data.

Referring to FIGS. 5 and 6, the encoder 250 may include a prediction-quantizer 251, an entropy encoder 252, and a bit rate controller 253, and the decoder 260 may include an entropy decoder 261 and a scaler 262.

First, the memory control circuit 270 may read a stress table from the memory 1200 and may transmit the stress table to the decoder 260, and the decoder 260 may decode the stress table. The entropy decoder 261 may decode the stress table by using an entropy coding method. The scaler 262 may restore quantized values to a continuous value, and may reconstruct data that has been lost or transformed due to compression. For example, the scaler 262 may reconstruct data by combining a prediction value of each stress element with a residual.

The fetch circuit 240 may read first accumulated stress data including stress elements of a current slice from the stress table decoded by the decoder 260 and may transmit the first accumulated stress data to the summing circuit 230.

The summing circuit 230 may receive new stress data of the current slice generated by the stress conversion circuit 220, and may generate second accumulated stress data by summing the new stress data and the first accumulated stress data. In an embodiment, the summing circuit 230 may compensate for a truncation error due to data compression, by summing the first accumulated stress data, the new stress data, and dithering data. The summing circuit 230 may output the second accumulated stress data to the encoder 250.

The prediction-quantizer 251 may reduce the size of the second accumulated stress data by using a prediction method of generating a prediction value of a current stress element, by using a function of previous stress elements. The prediction-quantizer 251 may process the second accumulated stress data by using any one of at least two prediction methods. In some aspects, the prediction-quantizer 251 may quantize the second accumulated stress data in order to reduce the size of the second accumulated stress data.

In an embodiment, the prediction-quantizer 251 may use a median adaptive prediction method. For example, referring to FIG. 7, a prediction value (p) of a current stress element x may be expressed as a function value based on three stress elements (e.g., a left element a, an upper element b, and a diagonal element c) which are adjacent to the current stress element x. The prediction value (p) of the current stress element x may be estimated as a medium value (a, b, (a+b-c)) of the left element a, the upper element b, and the diagonal element c.

The prediction-quantizer 251 may use a selective reference prediction method. The prediction value (p) of the current stress element x may be estimated by determining, from among two stress elements (e.g., the left element a and the upper element b) located adjacent to the current stress element x, the stress element which has a value having a higher similarity to the value of the current stress element x. In an example in which an absolute value (abs(a−x)) of a difference between the left element a and the current stress element x is greater than an absolute value (abs(b−x)) of a difference between the upper element b and the current stress element x, the prediction value (p) of the current stress element x may be estimated as a value of the upper element b.

Each of the stress element a, the stress element b, and the stress element c may indicate an accumulated stress (stress value) associated with a corresponding sub-pixel of the display panel 10.

The selective reference prediction method may be represented by the following algorithm expressed by Equation 1.

```
[Equation 1]
If(abs(a-x) > abs(b-x))
  p = b, direction = 1;
else
  p = a, direction = 0;
```

The selective reference prediction method includes using an additional bit for storing a direction of a selected stress element regarding which of the previous stress elements a and b is estimated as the prediction value of the current stress element x. In this case, the direction of the selected stress element may be stored by using a run-length encoding method, thereby reducing the size of the second accumulated stress data.

The entropy encoder 252 may encode the second accumulated stress data processed by the prediction-quantizer 251, by using an entropy coding method. The entropy coding method may involve encoding data by using probability and statistical data, and the used probability and statistical data may be included in a bitstream of the encoded second accumulated stress data. In an embodiment, part of the encoded second accumulated stress data may be encoded by using a run-length encoding method.

The bit rate controller 253 may compare a data size of the encoded second accumulated stress data with a target size, may output the encoded second accumulated stress data to the memory control circuit 270 when the data size is equal to or less than the target size (i.e., based on the bit rate controller 253 determining, by the comparison, that the data size is equal to or less than the target size), and may re-encode the second accumulated stress data by using a prediction method different from a previous prediction method when the data size is greater than the target size (i.e., based on the bit rate controller 253 determining, by the comparison, that the data size is greater than the target size). Hereinafter, an iterative operation of the encoder 250 by the bit rate controller 253 will be described with reference to FIG. 6.

First, the encoder 250 may process and encode second accumulated stress data by using a first prediction method (S110). The prediction-quantizer 251 may process and quantize the second accumulated stress data transmitted from the summing circuit 230 by using the first prediction method. The entropy encoder 252 may encode the second accumulated stress data processed by using the first prediction method, by using an entropy coding method.

The bit rate controller 253 compares a data size of the encoded second accumulated stress data with a target size (S120). In an example in which the data size of the encoded second accumulated stress data is equal to or less than the target size, the encoder 250 outputs the encoded second accumulated stress data to the memory control circuit 270, stores the second accumulated stress data to the memory 1200, and ends stress updating of a current slice.

When the data size of the encoded second accumulated stress data is greater than the target size, the encoder 250 re-encodes the second accumulated stress data by using a second prediction method different from the first prediction method (S130). The prediction-quantizer 251 processes and quantizes the second accumulated stress data transmitted from the summing circuit 230 by using the second prediction method. In an example in which the first prediction method is a median adaptive prediction method, the second prediction method may be a selective reference prediction method. In an example in which the first prediction method is a selective reference prediction method, the second prediction method may be a median adaptive prediction method. The entropy encoder 252 may re-encode the second accumulated stress data processed by using the second prediction method, by using an entropy coding method.

The bit rate controller 253 compares a data size of the second accumulated stress data re-encoded by using the second prediction method with the target size (S140). In an example in which the data size of the re-encoded second accumulated stress data is equal to or less than the target size, the encoder 250 outputs the re-encoded second accumulated stress data to the memory control circuit 270, stores the second accumulated stress data to the memory 1200, and ends stress updating of the current slice.

When the data size of the re-encoded second accumulated stress data is greater than the target size, the encoder 250 controls encoding precision (S150). For example, the encoder 250 may reduce a precision and increase a quantization level of the prediction-quantizer 251 and may re-encode the second accumulated stress data by using the first prediction method again (S110), using the updated quantization level of the prediction-quantizer 251. The encoder 250 may iterate the steps described herein with reference to FIG. 6 until the data size of the encoded second accumulated stress data is equal to or less than the target size. The number of iterations of the encoder 250 may vary for each slice.

The size of a slice may be determined based on complexity of an encoding algorithm and a target number of iterations. The target number of iterations may be a maximum value of the number of times of encoding performed until the data size of the second accumulated stress data is equal to or less than the target size. In general, when the encoder 250 lowers encoding precision by two steps, the data size of the encoded second accumulated stress data may be equal to or less than the target size. In this case, the target number of iterations may be, but is not limited to, 6.

When the same encoding algorithm is used, the size of a slice and a period of time associated with encoding the second accumulated stress data once (e.g., a period of time required to encode the second accumulated stress data once) may be proportional to each other. Because the data conversion circuit 1122 updates a stress table for one slice per frame, the size of a slice is determined such that the second accumulated stress data is repeatedly encoded a certain number of times (target number of iterations) during one frame.

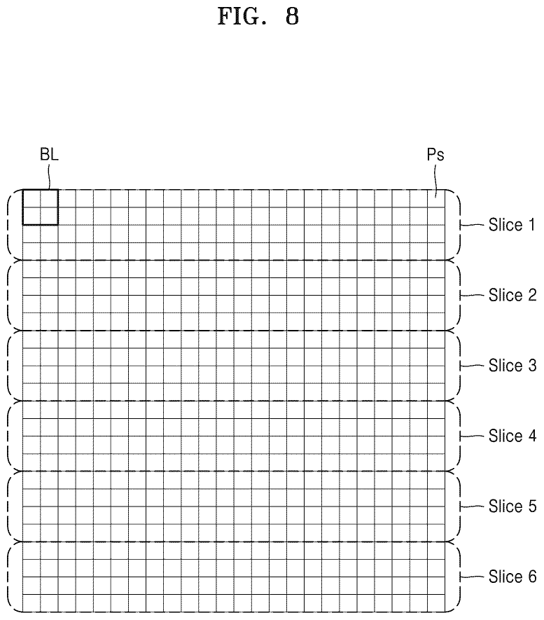

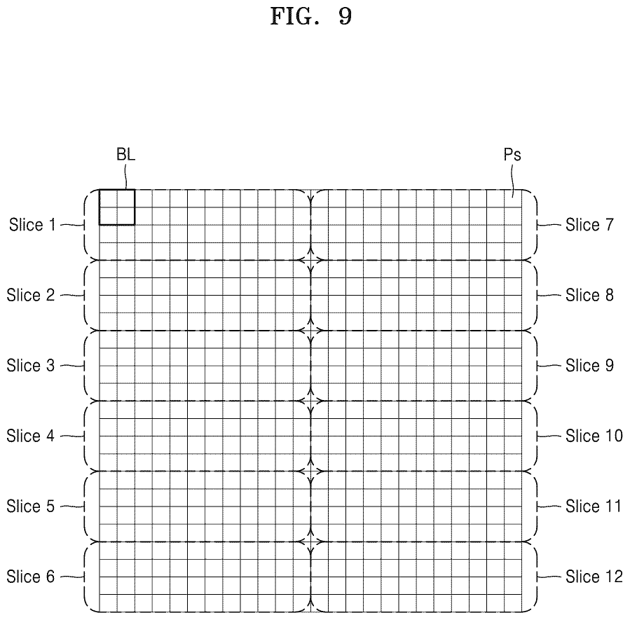

FIGS. 8 and 9 are diagrams schematically illustrating a display panel, according to an embodiment.

A stress table may be divided into a plurality of slices and may be encoded and decoded in units of slices. Each slice may correspond to an area having a substantially quadrangular shape in the display panel 10.

For example, a first slice of the stress table may include stress elements for estimating accumulated stress of sub-pixels Ps belonging to a first slice area Slice1 of the display panel 10. Each of slice areas Slice 1, Slice 2, . . . , and Slice 6 may have a constant size.

In an embodiment, as illustrated in FIG. 8, a width of each of the slice areas Slice 1, Slice 2, . . . , and Slice 6 in the first direction (x direction) may be the same as a width of the display panel 10. A height of each of the slice areas Slice 1, Slice 2, . . . , and Slice 6 may include a certain number of sub-pixel lines. For example, a height of each of the slice areas Slice 1, Slice 2, . . . , and Slice 6 may correspond to 4 lines, and a width of each of the slice areas Slice 1, Slice 2, . . . , and Slice 6 may correspond to 24 columns. The display panel 10 may be divided into 6 slice areas, and a stress table may include 6 slices corresponding to the 6 slice areas.

In an embodiment, as illustrated in FIG. 9, a width of each of the slice areas Slice 1, Slice 2, . . . , and Slice 12 in the first direction (x direction) may be different from a width of the display panel 10. For example, a height of each of the slice areas Slice 1, Slice 2, . . . , and Slice 12 may correspond to 4 lines, and a width of each of the slice areas Slice 1, Slice 2, . . . , and Slice 12 may correspond to 12 columns. The display panel 10 may be divided into 12 slice areas, and a stress table may include 12 slices corresponding to the 12 slice areas. The size of a slice is determined such that second accumulated stress data is repeatedly encoded a certain number of times (target number of iterations) during one frame.

A plurality of adjacent sub-pixels Ps, for example, 2×2 adjacent sub-pixels Ps, may be grouped into one block BL. Stress may be tracked and stored in units of blocks BL. For example, an average value of stresses of sub-pixels Ps belonging to a block BL may be stored as a stress element of the block BL. Each slice may include stress elements of the blocks BL included in a corresponding slice area.

For convenience of explanation, although the display panel 10 includes 24×24 sub-pixels Ps in FIGS. 8 and 9, the disclosure is not limited thereto. The display panel 10 may include more sub-pixels Ps and slice areas.

According to an embodiment as described herein, a display circuit board, an electronic device and a method of driving the electronic device which may display a high-quality image by reducing data truncation during afterimage compensation may be provided. However, the scope of the disclosure is not limited by this effect.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by one of ordinary skill in the art that various changes in form and details may be made therein without departing from the spirit and scope as defined by the following claims.

What is claimed is:

1. A display circuit board comprising:
an auxiliary processor which:
reads and decodes a stress table from a memory,
outputs a second image obtained by compensating for a first image based on the stress table,
generates new stress data for one slice, based on a grayscale of the second image,
generates second accumulated stress data by summing first accumulated stress data read from the stress table and the new stress data,
encodes the second accumulated stress data such that the encoded second accumulated stress data has a data size equal to or less than a target size, and
stores the encoded second accumulated stress data to the memory.

2. The display circuit board of claim 1, wherein the auxiliary processor, when encoding the second accumulated stress data, estimates a prediction value of a current stress element by using a function of previous stress elements.

3. The display circuit board of claim 2, wherein the auxiliary processor, based on a determination that a data size of the second accumulated stress data encoded by using a first prediction method is greater than the target size, re-encodes the second accumulated stress data by using a second prediction method different from the first prediction method.

4. The display circuit board of claim 3, wherein the auxiliary processor, based on a determination that a data size of the second accumulated stress data re-encoded by using the second prediction method is greater than the target size, increases a quantization level and re-encode the second accumulated stress data by using the first prediction method.

5. The display circuit board of claim 4, wherein a size of the one slice is determined such that the second accumulated stress data is repeatedly encoded a certain number of times during one frame.

6. The display circuit board of claim 3, wherein:
one of the first prediction method and the second prediction method comprises estimating a function value of three stress elements adjacent to the current stress element as the prediction value, and
the other of the first prediction method and the second prediction method comprises estimating a value having a higher similarity to a value of the current stress element from among two stress elements adjacent to the current stress element as the prediction value.

7. The display circuit board of claim 3, wherein the second accumulated stress data comprises a bit indicating a used prediction method from among the first prediction method and the second prediction method.

8. The display circuit board of claim 1, wherein the auxiliary processor generates the second accumulated stress data by further adding dithering data to the first accumulated stress data and the new stress data.

9. The display circuit board of claim 1, wherein the auxiliary processor updates the stress table for one slice during one frame.

10. The display circuit board of claim 1, wherein the auxiliary processor:
groups a plurality of sub-pixels into blocks; and
stores an average value of stresses of sub-pixels belonging to a block as a new stress element of the block.

11. The display circuit board of claim 1, wherein the auxiliary processor encodes the second accumulated stress data by using an entropy coding method.

12. An electronic device comprising:
a display panel; and
a display circuit board comprising an auxiliary processor,
wherein the auxiliary processor:
reads and decodes a stress table from a memory,
outputs a second image obtained by compensating for a first image based on the stress table,
generates new stress data for one slice, based on a grayscale of the second image,
generates second accumulated stress data by summing first accumulated stress data read from the stress table and the new stress data,
encodes the second accumulated stress data such that the encoded second accumulated stress data has a data size equal to or less than a target size, and
stores the encoded second accumulated stress data to the memory.

13. A method of driving an electronic device, the method comprising:
reading and decoding a stress table from a memory;
outputting a second image obtained by compensating for a first image based on the stress table;
generating new stress data for one slice, based on a grayscale of the second image;
generating second accumulated stress data by summing first accumulated stress data read from the stress table and the new stress data;
encoding the second accumulated stress data such that the encoded second accumulated stress data has a data size equal to or less than a target size; and
storing the encoded second accumulated stress data to the memory.

14. The method of claim 13, wherein the encoding of the second accumulated stress data comprises:
encoding the second accumulated stress data by using a first prediction method;
comparing a data size of the second accumulated stress data encoded by using the first prediction method with the target size; and
based on determining the data size is greater than the target size, re-encoding the second accumulated stress data by using a second prediction method different from the first prediction method.

15. The method of claim 14, wherein the encoding of the second accumulated stress data further comprises:
comparing a data size of the second accumulated stress data re-encoded by using the second prediction method with the target size; and
based on determining the data size is greater than the target size, increasing a quantization level and re-encoding the second accumulated stress data by using the first prediction method.

16. The method of claim 14, wherein:
one of the first prediction method and the second prediction method comprises estimating a function value of three stress elements adjacent to a current stress element as a prediction value, and
the other of the first prediction method and the second prediction method comprises estimating a value having a higher similarity to a value of the current stress element from among two stress elements adjacent to the current stress element as the prediction value.

17. The method of claim 13, wherein the generating of the second accumulated stress data further comprises adding dithering data to the first accumulated stress data and the new stress data.

18. The method of claim 13, wherein the stress table is updated for one slice per frame.

19. The method of claim 13, wherein the generating of the new stress data comprises:
grouping a plurality of sub-pixels into blocks; and
storing an average value of stresses of sub-pixels belonging to a block as a new stress element of the block.

20. The method of claim 13, wherein the second accumulated stress data is encoded by using an entropy coding method.
